(19) United States
(12) Patent Application Publication
(10) Pub. No.: US 2023/0127787 A1
(43) Pub. Date: Apr. 27, 2023

(54) METHOD AND APPARATUS FOR CONVERTING VOICE TIMBRE, METHOD AND APPARATUS FOR TRAINING MODEL, DEVICE AND MEDIUM

(71) Applicant: BEIJING BAIDU NETCOM SCIENCE TECHNOLOGY CO., LTD., Beijing (CN)

(72) Inventors: Junchao Wang, Beijing (CN); Yixiang Chen, Beijing (CN); Tao Sun, Beijing (CN)

(73) Assignee: BEIJING BAIDU NETCOM SCIENCE TECHNOLOGY CO., LTD., Beijing (CN)

(21) Appl. No.: 18/145,326

(22) Filed: Dec. 22, 2022

(30) Foreign Application Priority Data
Dec. 22, 2021 (CN) 202111579876.2

(51) Int. Cl. G10L 15/02; G10L 15/06

(52) U.S. Cl. CPC G10L 15/02; G10L 15/063; G10L 2015/025

(57) ABSTRACT

A method and an apparatus for converting a voice timbre, and a method for training a model. The solution includes: obtaining a target acoustic feature by encoding a sample audio using an encoding branch in a voice timbre conversion model; obtaining a target text feature by performing feature extraction on a real text sequence labeled by the sample audio; training the encoding branch based on a difference between the target acoustic feature and the target text feature; obtaining a first spectrum feature having an original timbre by decoding the target text feature using a decoding branch in the voice timbre conversion model based on the original timbre corresponding to the identification information carried in the sample audio; obtaining a second spectrum feature by performing spectrum feature extraction on the sample audio; and training the decoding branch based on a difference between the first spectrum feature and the second spectrum feature.

### CROSS REFERENCE TO RELATED APPLICATIONS

This application is based on and claims priority to Chinese Patent Applications Serial No. 202111579876.2 filed on Dec. 22, 2021, the entire contents of which are incorporated herein by reference.

### TECHNICAL FIELD

The disclosure relates to a field of artificial intelligence, specifically to fields of deep learning, voice synthesis and computer vision technologies, and particularly to a method and an apparatus for converting a voice timbre, a method and an apparatus for training a model, a device and a medium.

### BACKGROUND

A voice conversion technology, also referred to as a voice timbre conversion technology, as a research branch of voice signal processing, covering contents in the fields of speaker recognition, voice recognition, voice synthesis, etc., is a technology that changes personalized information of voice in case of keeping the original semantic information unchanged, which makes the voice of a specific speaker (that is, a source speaker) sounds like the voice of another specific speaker (that is, a target speaker).

### SUMMARY

A method and an apparatus for converting a voice timbre, a method and an apparatus for training a model, a device and a medium are provided in the disclosure.

According to one aspect of the disclosure, a method for training a model is provided, and includes: acquiring a sample audio carrying identification information, and obtaining a target acoustic feature by encoding the sample audio using an encoding branch in a voice timbre conversion model; obtaining a target text feature by performing feature extraction on the real text sequence labeled by the sample audio; training the encoding branch based on a first difference between the target acoustic feature and the target text feature, and obtaining a first spectrum feature having an original timbre corresponding to the identification information by decoding the target text feature using a decoding branch in the voice timbre conversion model based on the original timbre; and obtaining a second spectrum feature by performing spectrum feature extraction on the sample audio, and training the decoding branch based on a second difference between the first spectrum feature and the second spectrum feature.

According to another aspect of the disclosure, a method for converting a voice timbre is provided, and includes: acquiring a source voice and a target identifier; obtaining a target acoustic feature by encoding the source voice using an encoding branch in a voice timbre conversion model; obtaining a spectrum feature having a target timbre by decoding the target acoustic feature using a decoding branch in the voice timbre conversion model based on the target timbre corresponding to the target identifier; and obtaining a target voice corresponding to the target timbre by performing voice restoration on the spectrum feature using a vocoder.

According to another aspect of the disclosure, an electronic device is provided, and includes: at least one processor; and a memory communicatively connected to the at least one processor; the memory is stored with instructions executable by the at least one processor, the instructions are performed by the at least one processor, to cause the at least one processor to perform the method for converting a voice timbre as described in the another aspect of the disclosure, or to perform the method for training a model as described in the above aspect of the disclosure.

According to another aspect of the disclosure, a non-transitory computer readable storage medium stored with computer instructions is provided, the computer instructions are configured to perform the method for converting a voice timbre as described in another aspect or the method for training a model as described in the above aspect by a computer.

According to another aspect of the disclosure, a computer program product including a computer program is provided. The computer program implements the method for converting a voice timbre as described in another aspect or the method for training a model as described in the above aspect when performed by a processor.

It should be understood that, the content described in the part is not intended to identify key or important features of embodiments of the disclosure, nor intended to limit the scope of the disclosure. Other features of the disclosure will be easy to understand through the following specification.

### BRIEF DESCRIPTION OF THE DRAWINGS

The drawings are intended to better understand the solution, and do not constitute a limitation to the disclosure.

FIG. 1 is a flowchart of a method for training a model provided in a first embodiment of the disclosure;

FIG. 2 is a flowchart of a method for training a model provided in a second embodiment of the disclosure;

FIG. 3 is a flowchart of a method for training a model provided in a third embodiment of the disclosure;

FIG. 4 is a diagram of a training process of a second feature extraction network provided in a fourth embodiment of the disclosure;

FIG. 5 is a flowchart of a method for training a model provided in a fifth embodiment of the disclosure;

FIG. 6 is a diagram of a training process of a voice timbre conversion model provided in a sixth embodiment of the disclosure;

FIG. 7 is a flowchart of a method for converting a voice timbre provided in a seventh embodiment of the disclosure;

FIG. 8 is a flowchart of a method for converting a voice timbre provided in an eighth embodiment of the disclosure;

FIG. 9 is a diagram of a prediction process of a voice timbre conversion model provided in a ninth embodiment of the disclosure;

FIG. 10 is a diagram of a structure of an apparatus for training a model provided in a ninth embodiment of the disclosure;

FIG. 11 is a diagram of a structure of an apparatus for converting a voice timbre provided in an eighth embodiment of the disclosure;

FIG. 12 is a schematic block diagram illustrating an example electronic device in any embodiment of the disclosure.

### DETAILED DESCRIPTION

The exemplary embodiments of the present disclosure are described as below with reference to the accompanying drawings, which include various details of embodiments of the present disclosure to facilitate understanding, and should be considered as merely exemplary. Therefore, those skilled in the art should realize that various changes and modifications may be made to the embodiments described herein without departing from the scope and spirit of the present disclosure. Similarly, for clarity and conciseness, descriptions of well-known functions and structures are omitted in the following descriptions.

With increasing attention on voice conversion, the technical direction is classified into a parallel corpus direction and a non-parallel corpus direction based on division of the corpus required by a model. Voice conversion aims to convert a timbre of a voice of a source speaker into a timbre of a target speaker, and keep the expression content (that is, semantic information) of the voice unchanged.

Parallel corpus voice conversion means that a source speaker and a target speaker are required to record an audio of the same text when recording the required corpus. When a model is trained, due to different voice speeds of different people, durations of the recorded voices may be different when different people read the same sentence, therefore, the lengths of audio feature sequences of the source speaker and the target speaker extracted from the audio having the same text content may be different. Therefore, the length of the audio feature sequence of the source speaker needs to be aligned to the length of the audio feature sequence of the target speaker by some alignment methods, so that a model may be constructed, with which the audio feature sequence of the target speaker may be predicted by inputting the audio feature sequence of the source speaker. In a test phase, an audio feature is extracted from a voice of a source speaker, and the extracted audio feature sequence of the source speaker is input into the model, and the model predicts an audio feature sequence of a target speaker, and then a vocoder converts the predicted audio feature sequence into a voice.

For example, assuming that the source speaker is A, the target speaker is B, A and B are required to record audios of a set of texts simultaneously when an A-to-B parallel corpus voice conversion system needs to be constructed. Assuming that one sentence of text content is “I want to go to school”, A reads this sentence for 1.2 s, 120 audio frames may be extracted, so that the audio feature sequence includes 120 elements; B reads this sentence for 1.5 s, 150 audio frames may be extracted, so that the audio feature sequence includes 150 elements. Based on a sequence alignment method, the length of the audio feature sequence of A is aligned with the length of the audio feature sequence of B, that is, the audio feature sequence of A is extended to 150 elements, so that the two audio feature sequences may be fitted through the model.

In non-parallel corpus voice conversion, a voice of a target speaker needs to be recorded, and a voice of a source speaker is not required during training, a common method includes a phoneme probability graph-based method and a self-reconfiguration method.

In the phoneme probability graph-based method, first, a phonetic posteriorgram (ppg) feature that expresses a speaking content is extracted from an audio of the target speaker through a voice recognition model, and then a relationship between the ppg feature and a Mel feature of the audio is modeled using a model. During test, the source speaker extracts the ppg feature through the voice recognition model, and inputs the ppg feature into a trained voice timbre conversion model, to obtain a feature after voice timbre conversion.

The overall thinking of the self-reconfiguration method is: during a training phase, content information and timbre information in the acoustic feature corresponding to the audio are decoupled by an encoder, and restored by a decoder for self-reconfiguration training.

At present, since the parallel corpus voice conversion based on the ppg feature has a wide application range, it is generally adopted to construct a voice conversion system in industry. However, content information expressed by the ppg feature still contains much speaker information (for example, timbre information), resulting in insufficient decoupling of the speaking content and the timbre of the source speaker in an actual voice conversion process, and further resulting in the timbre of the audio after voice conversion not matching the timbre of the target speaker.

For the above problem, the disclosure provides a method and an apparatus for converting a voice timbre, a method and an apparatus for training a model, a device and a medium.

A method and an apparatus for converting a voice timbre, a method and an apparatus for training a model, a device and a medium in the embodiment of the disclosure are described below with reference to accompanying drawings.

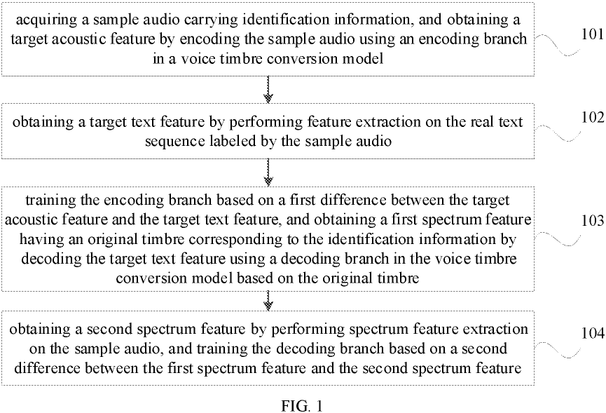

FIG. 1 is a flowchart of a method for training a model provided in a first embodiment of the disclosure.

The embodiment is illustrated by configuring the method for training a model in an apparatus for training a model. The apparatus for training a model may be applied in any electronic device to cause the electronic device to perform a model training function.

The electronic device may be any device with computation ability, for example, may be a personal computer, a mobile terminal, a server, etc. The mobile terminal may be a hardware device with an operating system, a touch screen and/or a display screen, such as a mobile phone, a tablet computer, a personal digital assistant and a wearable device.

As illustrated in FIG. 1, the method for training a model may include the following blocks.

At block 101, a sample audio carrying identification information is acquired, and a target acoustic feature is obtained by encoding the sample audio using an encoding branch in a voice timbre conversion model.

In the embodiment of the disclosure, the method for acquiring the sample audio is not limited, for example, the sample audio may be acquired from an existing training set, or further may be generated based on the way of manual input, which is not limited in the disclosure.

In the embodiment of the disclosure, the identification information carried by the sample audio is configured to identify a speaker (or an enunciator) corresponding to the sample audio. For example, identification information may be an identity (for example, an ID) of the speaker.

For example, when a speaker A records one sentence to obtain a sample audio 1, the identification information carried in the sample audio 1 may be an ID of the speaker A, for another example, when a speaker B records one sentence to obtain a sample audio 2, the identification information carried in the sample audio 2 may be an ID of the speaker B.

In the embodiment of the disclosure, the target acoustic feature may be obtained by encoding the sample audio using the encoding branch in the voice timbre conversion model.

At block 102, a target text feature is obtained by performing feature extraction on a real text sequence labeled by the sample audio.

In the embodiment of the disclosure, the target text feature may be obtained by performing feature extraction on the real text sequence labeled by the sample audio based on a text coding way.

At block 103, the encoding branch is trained based on a first difference between the target acoustic feature and the target text feature, and a first spectrum feature having an original timbre corresponding to the identification information is obtained by decoding the target text feature using a decoding branch in the voice timbre conversion model based on the original timbre.

In the embodiment of the disclosure, the encoding branch in the voice timbre conversion model may be trained based on the first difference between the target acoustic feature and the target text feature. For example, a first loss function corresponding to the encoding branch may be generated based on the first difference, a value of the first loss function is positively related to the first difference, that is, the smaller the first difference, the smaller the value of the first loss function, and the larger the first difference, the greater the value of the first loss function.

It should be noted that, the above only takes a termination condition of training the encoding branch being minimizing the value of the first loss function for an example, other termination conditions further may be set in actual applications, for example, the termination condition further may be that the number of times of training reaches a preset threshold, which is not limited in the disclosure.

It should be understood that, the encoding branch is guided to be trained based on the text feature corresponding to the real text sequence labeled by the sample audio, so that the acoustic feature output by the encoding branch is more prone to including content information (or semantic information) in the sample audio, but not including speaker information (such as timbre information), or including less speaker information, thereby improving the timbre effect of subsequent voice conversion.

In the embodiment of the disclosure, the spectrum feature (which is denoted as the first spectrum feature in the disclosure) having the original timbre corresponding to the identification information may be obtained by decoding by the decoding branch in the voice timbre conversion model the target text feature based on the original timbre. For example, the first spectrum feature may be a Mel feature, a Mel-frequency cepstral coefficient (MFCC) feature or other spectrum features.

At block 104, a second spectrum feature is obtained by performing spectrum feature extraction on the sample audio, and the decoding branch is trained based on a second difference between the first spectrum feature and the second spectrum feature.

In the embodiment of the disclosure, spectrum feature extraction may be performed on the sample audio to obtain the spectrum feature which is denoted as the second spectrum feature, the second spectrum feature may be a Mel feature, an MFCC feature or other spectrum features.

In the embodiment of the disclosure, the decoding branch in the voice timbre conversion model may be trained based on the second difference between the first spectrum feature and the second spectrum feature. The purpose of training the decoding branch is to learn a corresponding relationship between identification information and a timbre, that is, in a training process of the decoding branch, the original timbre corresponding to the identification information may be updated based on the second difference between the first spectrum feature and the second spectrum feature, so that the updated original timbre matches the timbre corresponding to the sample audio.

As a possible implementation, a second loss function corresponding to the decoding branch may be generated based on the second difference, a value of the second loss function is positively related to the second difference, that is, the smaller the second difference, the smaller the value of the second loss function, and the larger the second difference, the greater the value of the second loss function.

It should be noted that, the above only takes a termination condition of training the decoding branch being minimizing the value of the second loss function for an example, other termination conditions may be further set in actual application, for example, the termination condition further may be that the number of times of training reaches a preset threshold, which is not limited in the disclosure.

As an example, different sample audios may be recorded by different speakers (such as a child, a female adult, a male adult, the elderly etc.) in advance. Each sample audio carries identification information of a corresponding speaker, therefore, in any method embodiment of the disclosure, the encoding branch and the decoding branch in the voice timbre conversion model may be trained based on the sample audio, so that the voice timbre conversion model may learn a corresponding relationship between the identification information and a timbre, for example, learn a corresponding relationship between the identification information of a child and a timbre of a child, and a corresponding relationship between the identification information of the elderly and a timbre of the elderly.

Further, during a prediction phase, a voice input by any one user may be denoted as a source voice in the disclosure, and timbre conversion may be performed on the source voice using the voice timbre conversion model, to obtain a target voice. For example, when a user wants to covert the timbre of his own source voice to a child timbre, the voice timbre conversion model may be adopted to perform timbre conversion on the source voice based on the target timbre corresponding to the identification information of the child, to obtain a target voice having the target timbre.

In the method for training a model in the embodiment of the disclosure, the target acoustic feature is obtained by encoding the sample audio using the encoding branch in the voice timbre conversion model, and the target text feature is obtained by performing feature extraction on the real text sequence labeled by the sample audio; the encoding branch is trained based on the first difference between the target acoustic feature and the target text feature, and the first spectrum feature having the original timbre corresponding to the identification information is obtained by decoding by the decoding branch in the voice timbre conversion model the target text feature based on the original timbre carried in the sample audio; the second spectrum feature is obtained by performing spectrum feature extraction on the sample audio, and the decoding branch is trained based on the second difference between the first spectrum feature and the second spectrum feature. Therefore, the encoding branch is trained based on the difference between the text feature corresponding to the real text sequence labeled by the sample audio and the acoustic feature output by the encoding branch, so that the acoustic feature output by the encoding branch is more prone to including content information (or semantic information) in the sample audio, but not including speaker information (such as timbre information), thereby improving the timbre effect of subsequent voice conversion.

It should be noted that, collection, storage, use, processing, transmission, provision and disclosure of the user personal information (for example, a sample audio, identification information, a source voice, etc.) involved in the technical solution of the disclosure are performed with the consent of the user, comply with relevant laws and regulations, and do not violate public order and good customs.

In order to clarify how the encoding branch in the voice timbre conversion model encodes the sample audio in the embodiment of the disclosure, a method for training a model is further provided in the disclosure.

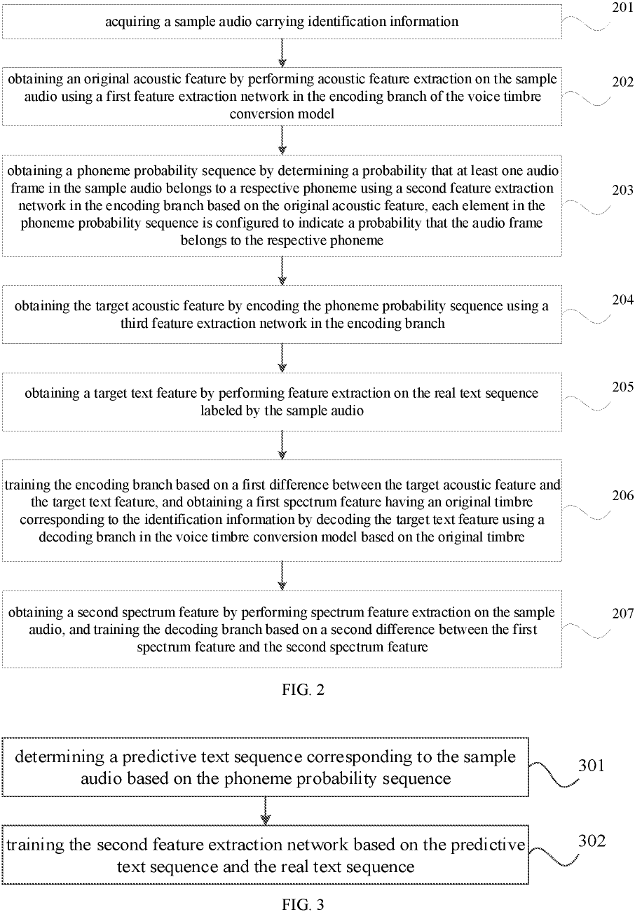

FIG. 2 is a flowchart of a method for training a model provided in a second embodiment of the disclosure.

As illustrated in FIG. 2, the method for training a model may include the following blocks.

At block 201, a sample audio carrying identification information is acquired.

The execution process of block 201 may refer to the above embodiment, which will not be repeated here.

At block 202, an original acoustic feature is obtained by performing acoustic feature extraction on the sample audio using a first feature extraction network in an encoding branch of a voice timbre conversion model.

In the embodiment of the disclosure, the original acoustic feature may be a Mel feature, a filter bank (Fbank) feature or other acoustic features.

In the embodiment of the disclosure, the original acoustic feature may be obtained by performing acoustic feature extraction on the sample audio using the first feature extraction network in the encoding branch of the voice timbre conversion model.

At block 203, a phoneme probability sequence is obtained by determining a probability that at least one audio frame in the sample audio belongs to a respective phoneme using a second feature extraction network in the encoding branch based on the original acoustic feature, each element in the phoneme probability sequence is configured to indicate a probability that the audio frame belongs to the respective phoneme.

In the embodiment of the disclosure, a phoneme may be understood as a basic unit of pronunciation, each audio frame corresponds to one basic pronunciation unit.

In the embodiment of the disclosure, the phoneme probability sequence, may be also referred to as a phoneme probability graph feature, a ppg feature, in this case, the second feature extraction network may be a phoneme probability graph network (or a phoneme probability graph submodel), a ppg network (or a ppg submodel).

In the embodiment of the disclosure, the phoneme probability sequence may be obtained by determining the probability that at least one audio frame in the sample audio belongs to the respective phoneme using the second feature extraction network in the encoding branch in the voice timbre conversion model based on the original acoustic feature, each element in the phoneme probability sequence is configured to indicate the probability that the audio frame belongs to the respective phoneme.

For example, assuming that a duration of a sample audio is 1.2 s, and one audio frame is extracted per 0.01 s, the sample audio has 120 audio frames, and the phoneme probability sequence has 120 elements, each element is configured to indicate the probability that a corresponding audio frame belongs to the respective phoneme.

At block 204, a target acoustic feature is obtained by encoding the phoneme probability sequence using a third feature extraction network in the encoding branch.

In the embodiment of the disclosure, a deeper-layer acoustic feature (which may be denoted as the target acoustic feature in the disclosure) may be extracted by encoding the phoneme probability sequence using the third feature extraction network in the encoding branch of the voice timbre conversion model.

At block 205, a target text feature is obtained by performing feature extraction on a real text sequence labeled by the sample audio.

At block 206, the encoding branch is trained based on a first difference between the target acoustic feature and the target text feature, and a first spectrum feature having an original timbre corresponding to the identification information is obtained by decoding by a decoding branch in the voice timbre conversion model the target text feature based on the original timbre.

At block 207, a second spectrum feature is obtained by performing spectrum feature extraction on the sample audio, and the decoding branch is trained based on a second difference between the first spectrum feature and the second spectrum feature.

The execution process of blocks 205 to 207 may refer to an execution process of any embodiment in the disclosure, which will not be repeated here.

In the embodiment of the disclosure, the original acoustic feature is obtained by performing acoustic feature extraction on the sample audio using the first feature extraction network in the encoding branch; the phoneme probability sequence is obtained by determining the probability that at least one audio frame in the sample audio belongs to the respective phoneme using the second feature extraction network in the encoding branch based on the original acoustic feature, each element in the phoneme probability sequence is configured to indicate a probability that the audio frame belongs to the respective phoneme; and the target acoustic feature is obtained by encoding the phoneme probability sequence using the third feature extraction network in the encoding branch. Therefore, the target acoustic feature may be obtained by effectively encoding the sample audio by three feature extraction networks in the encoding branch.

In a possible implementation in the embodiment of the disclosure, in order to enhance the accuracy and effectiveness of the acoustic feature output by the encoding branch, the second feature extraction network in the encoding branch may be further trained. In combination with FIG. 3, the above process is described in detail.

FIG. 3 is a flowchart of a method for training a model provided in a third embodiment of the disclosure.

As illustrated in FIG. 3, on the basis of the embodiment as illustrated in FIG. 1 or FIG. 2, the method for training a model further may include the following blocks.

At block 301, a predictive text sequence corresponding to the sample audio is determined based on the phoneme probability sequence.

In the embodiment of the disclosure, the predictive text sequence corresponding to the sample audio may be determined based on the phoneme probability sequence, that is, the predictive text sequence corresponding to the sample audio may be determined based on each element in the phoneme probability sequence.

For example, assuming that the phoneme probability sequence has 4 elements, a first element indicates that the probability of a first audio frame belongs to a phoneme 1 is maximum, a second element indicates that the probability of a second audio frame belongs to a phoneme 2 is maximum, a third element indicates that the probability of a third audio frame belongs to a phoneme 3 is maximum, and a fourth element indicates that the probability of a fourth audio frame belongs to a phoneme 4 is maximum, in this case, the predictive text sequence may be determined based on the phoneme 1, the phoneme 2, the phoneme 3 and the phoneme 4.

At block 302, the second feature extraction network is trained based on the predictive text sequence and the real text sequence.

In the embodiment of the disclosure, the second feature extraction network may be trained based on the predictive text sequence and the real text sequence. For example, a loss function corresponding to the second feature extraction network may be generated based on the difference between the predictive text sequence and the real text sequence, the loss function is positively related to the difference, so that the second feature extraction network may be trained based on a value of the loss function to minimize the value of the loss function.

It needs to be noted that, the disclosure takes training the second feature extraction network, the encoding branch (for example, the first feature extraction network and the third feature extraction network) and the decoding branch in the voice timbre conversion model using the same sample audio for an example, however, in an actual application, another sample audio may be adopted to pre-train the second feature extraction network, and then, in a training process of the voice timbre conversion model, each feature extraction network in the encoding branch and the decoding branch are trained simultaneously using the same sample audio, which will not be limited in the disclosure.

It needs to be noted that, the length of the predictive text sequence matches the frame number of the audio frames corresponding to the sample audio, when the frame number of the audio frames of the sample audio varies, the length of the predictive text sequence is changed, however the length of the real text sequence labeled by the sample audio is determined, in this case, the length of the real text sequence may not match the length of the predictive text sequence. For example, the real text sequence is “abcd”, the length of the real text sequence is 4, while the predictive text sequence is “AAABBCCCD”, the length of the predictive text sequence is 9.

Therefore, in a possible implementation of the embodiment of the disclosure, in order to improve a prediction effect of the second feature extraction network, a sequence alignment method may be adopted to perform alignment processing on the real text sequence based on the length of the predictive text sequence, so that the length of the aligned real text sequence matches the length of the predictive text sequence. Taking the above example for an example, the sequence alignment method may be adopted to align the real text sequence to “aaabbcccd”.

As an example, a Gaussian Mixture Model, a Hidden Markov Model and other deep learning models may be adopted to perform alignment processing on the real text sequence based on the length of the predictive text sequence, so that the length of the aligned real text sequence matches the length of the predictive text sequence.

Therefore, in the disclosure, the second feature extraction network may be trained based on a third difference between the predictive text sequence and the aligned real text sequence. For example, a third loss function corresponding to the second feature extraction network may be generated based on the third difference, a value of the third loss function is positively related to the third difference, that is, the smaller the third difference, the smaller the value of the third loss function, and the larger the third difference, the greater the value of the third loss function.

It should be noted that, the above only takes a termination condition of training the second feature extraction network being minimizing the value of the third loss function for an example, other termination conditions further may be set in actual applications, for example, the termination condition may be further that a number of times of training reaches a preset threshold, which is not limited in the disclosure.

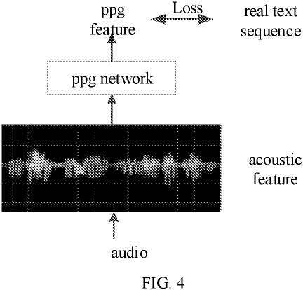

As an example, taking the second feature extraction network in the encoding branch being a ppg network (or a ppg submodel) and the phoneme probability sequence being a ppg feature for an example, the training process of the second feature extraction network may be as illustrated in FIG. 4, acoustic feature extraction may be performed on the sample audio using the first feature extraction network in the encoding branch, and the extracted original acoustic feature is input into the second feature extraction network (that is, a ppg network), and the second feature extraction network predicts the probability that each audio frame in the sample audio belongs to the respective phoneme based on the original acoustic feature to obtain the phoneme probability sequence (that is, a ppg feature).

Then, the predictive text sequence may be determined based on the phoneme probability sequence, and a sequence alignment method may be adopted to force the length of the real text sequence labeled by the sample audio to be aligned to the length of the predictive text sequence, so that a loss function corresponding to the second feature extraction network may be generated based on the difference between the length of the predictive text sequence and the length of the aligned real text sequence, and further the second feature extraction network may be trained based on the loss function.

In the method for training a model in the embodiment of the disclosure, the predictive text sequence corresponding to the sample audio is determined based on the phoneme probability sequence; and the second feature extraction network is trained based on the predictive text sequence and the real text sequence. Therefore, by training the second feature extraction network, which may a prediction effect of the encoding branch is improved.

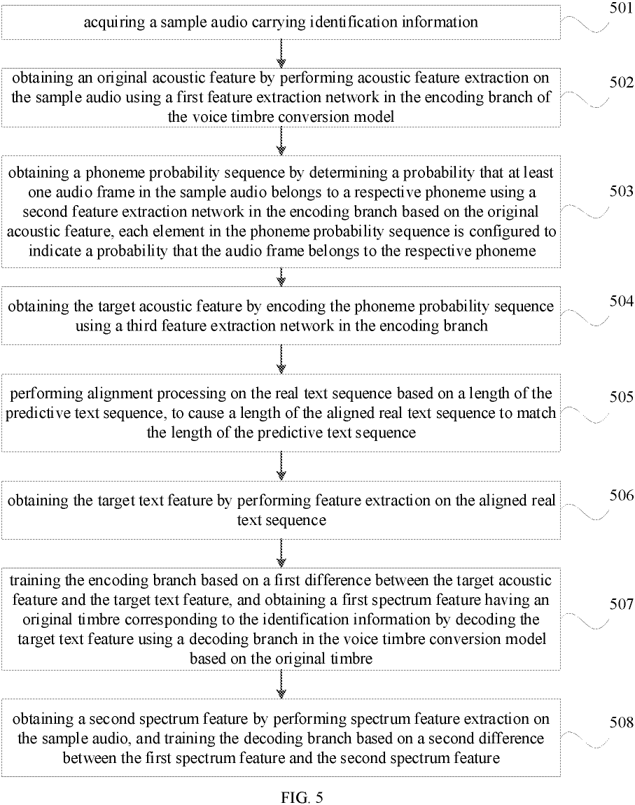

Similar with the principle as illustrated in FIG. 3, the length of the target acoustic feature matches the length of the phoneme probability sequence, and the length of the predictive text sequence matches the frame number of the audio frames corresponding to the sample audio, however, the length of the real text sequence may not match the frame number of the audio frames, therefore, in order to improve the training effect of the decoding branch, alignment processing may be performed on the real text sequence based on the length of the phoneme probability sequence, so that feature extraction is performed on the aligned real text sequence, the length of the extracted target text feature matches the length of the target acoustic feature, and further the encoding branch is trained using two features with a matched length, which may improve the training effect of the encoding branch. In combination with FIG. 5, the above process is described in detail.

FIG. 5 is a flowchart of a method for training a model provided in a fifth embodiment of the disclosure.

As illustrated in FIG. 5, the method for training a model may include the following blocks.

At block 501, a sample audio carrying identification information is acquired.

At block 502, an original acoustic feature is obtained by performing acoustic feature extraction on the sample audio using a first feature extraction network in an encoding branch of a voice timbre conversion model.

At block 503, a phoneme probability sequence is obtained by determining a probability that at least one audio frame in the sample audio belongs to a respective phoneme using a second feature extraction network in the encoding branch based on the original acoustic feature, each element in the phoneme probability sequence is configured to indicate a probability that the audio frame belongs to the respective phoneme.

At block 504, a target acoustic feature is obtained by encoding the phoneme probability sequence using a third feature extraction network in the encoding branch.

The execution process of blocks 501 to 504 may refer to an execution process of any embodiment in the disclosure, which will not be repeated here.

At block 505, alignment processing is performed on a real text sequence labeled by the sample audio based on a length of the phoneme probability sequence, so that a length of the aligned real text sequence matches the length of the phoneme probability sequence.

In the embodiment of the disclosure, a sequence alignment method may be adopted to perform alignment processing on the real text sequence labeled by the sample audio based on the length of the phoneme probability sequence, so that the length of the aligned real text sequence matches the length of the phoneme probability sequence.

For example, assuming that the length of the phoneme probability sequence is 9, the predictive text sequence indicated by the phoneme probability sequence is “AAABBCCCD”, the length of the real text sequence is 4, and the real text sequence is “abcd”, in this case, the length of the real text sequence may be forced to align to the length of the phoneme probability sequence, and the aligned real text sequence may be “aaabbcccd”.

At block 506, a target text feature is obtained by performing feature extraction on the aligned real text sequence.

In the embodiment of the disclosure, the target text feature may be obtained by performing feature extraction on the aligned real text sequence based on a text coding way.

At block 507, the encoding branch is trained based on a first difference between the target acoustic feature and the target text feature, and a first spectrum feature having an original timbre corresponding to the identification information is obtained by decoding by a decoding branch in the voice timbre conversion model the target text feature based on the original timbre.

At block 508, a second spectrum feature is obtained by performing spectrum feature extraction on the sample audio, and the decoding branch is trained based on a second difference between the first spectrum feature and the second spectrum feature.

The execution process of blocks 507 to 508 may refer to an execution process of any embodiment in the disclosure, which will not be repeated here.

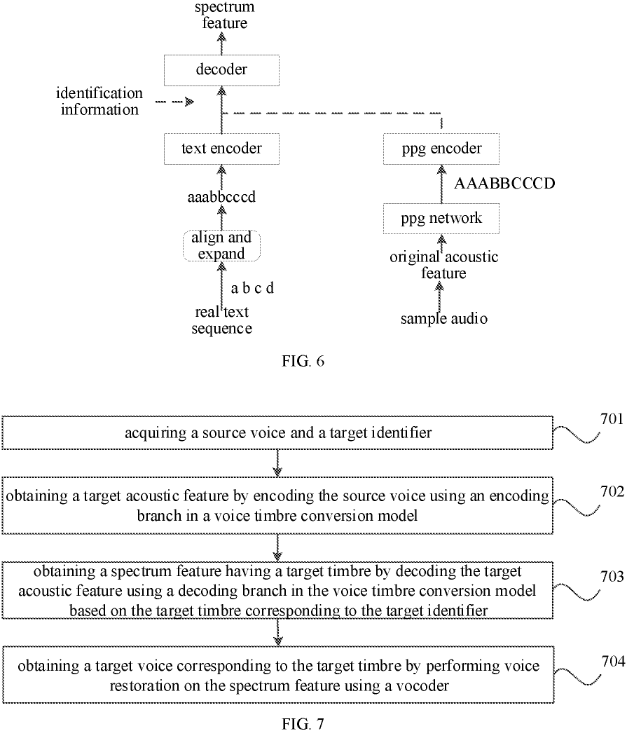

As an example, taking the second feature extraction network in the encoding branch being a ppg network (or a ppg submodel), the phoneme probability sequence being a ppg feature and the third feature extraction network being a ppg encoder for an example, the training process of the voice timbre conversion model may be as illustrated in FIG. 6, acoustic feature extraction may be performed on the sample audio using the first feature extraction network in the encoding branch, and the extracted original acoustic feature is input into the ppg network to obtain the ppg feature, and the ppg encoder encodes the ppg feature to extract a deeper-layer acoustic feature, which is denoted as the target acoustic feature in the disclosure.

Alignment processing may be performed on the real text sequence (for example, abcd) labeled by the sample audio based on the length of the pgg feature, and the text encoder encodes the aligned real text sequence to obtain the target text feature, thereby training the encoding branch based on the difference between the target text sequence and the target acoustic feature.

And, the decoding branch in the voice timbre conversion model further may decode the feature output by the text encoder based on the timbre corresponding to the identification information (for example, a speaker ID)carried by the sample audio, to obtain the first spectrum feature (for example, a Mel feature) having the above timbre, so that the decoding branch may be trained based on the difference between the second spectrum feature extracted from the sample audio and the first spectrum feature.

In the method for training a model in the embodiment of the disclosure, alignment processing is performed on the real text sequence based on the length of the phoneme probability sequence, to cause the length of the aligned real text sequence to match the length of the phoneme probability sequence; and the target text feature is obtained by performing feature extraction on the aligned real text sequence. Therefore, the encoding branch is trained using the difference between two features with the matched length, which may improve the training effect of the encoding branch.

The above is each embodiment corresponding to the method for training a voice timbre conversion model. A method for applying a voice timbre conversion model is further provided in the disclosure, that is, a method for converting a voice timbre.

FIG. 7 is a flowchart of a method for converting a voice timbre provided in a seventh embodiment of the disclosure.

As illustrated in FIG. 7, the method for converting a voice timbre may include the following blocks.

At block 701, a source voice and a target identifier are acquired.

In the embodiment of the disclosure, the method for acquiring the source voice is not limited, for example, the source voice may be acquired from an existing training set, or further may be generated based on the way of manual input, which is not limited in the disclosure.

In the embodiment of the disclosure, the target identifier is identification information corresponding to the timbre to be converted (denoted as a target timbre in the disclosure), and is determined based on a selection operation of a user. For example, a plurality of timbre conversion options may be set on a voice timbre conversion interface, each timbre conversion option corresponding to one identification information, for example, a child timbre option corresponding to identification information of a child, and an elderly timbre option corresponding to identification information of the elderly. When a user selects one timbre conversion option, the identification information corresponding to the selected timbre conversion option may be taken as the target identifier.

At block 702, a target acoustic feature is obtained by encoding the source voice using an encoding branch in a voice timbre conversion model.

In the embodiment of the disclosure, the voice timbre conversion model may be trained using a method for training a model in any of the above embodiments.

In the embodiment of the disclosure, the target acoustic feature may be obtained by encoding the source voice using the encoding branch in the voice timbre conversion model.

At block 703, a spectrum feature having a target timbre corresponding to the target identifier is obtained by decoding the target acoustic feature using a decoding branch in the voice timbre conversion model based on the target timbre.

In the embodiment of the disclosure, the decoding branch in the voice timbre conversion model has learned a corresponding relationship between identification information and a timbre, the target acoustic feature may be input into the decoding branch, and the decoding branch decodes the target acoustic feature based on the target timbre corresponding to the target identification to obtain the spectrum feature having the target timbre, the spectrum feature may be a Mel feature, an MFCC feature or other spectrum features.

At block 704, a target voice corresponding to the target timbre is obtained by performing voice restoration on the spectrum feature using a vocoder.

In the embodiment of the disclosure, the target voice corresponding to the target timbre is obtained by performing voice restoration on the spectrum feature using the vocoder.

As an application scene, a plurality of timbre conversion options may be set on the voice timbre conversion interface, for example, a child timbre option, a female timbre option, a male timbre option, an elderly timbre option, assuming that a source speaker selects the child timbre option, the voice timbre conversion model and the vocoder may perform timbre conversion on the source voice of the source speaker to obtain the target voice having a child timbre.

In the method for converting a voice timbre in the embodiment of the disclosure, the source voice and the target identifier are acquired, and the target acoustic feature is obtained by encoding the source voice using the encoding branch in the voice timbre conversion model; the spectrum feature having the target timbre corresponding to the target identifier is obtained by decoding the target acoustic feature using the decoding branch in the voice timbre conversion model based on the target timbre; and the target voice corresponding to the target timbre is obtained by performing voice restoration on the spectrum feature using the vocoder. Therefore, timbre conversion is performed on a voice based on a deep learning technology, which may improve a timbre conversion effect.

In order to clarify how the encoding branch in the above embodiment encodes the source voice to obtain the target acoustic feature, a method for converting a voice timbre is further provided in the disclosure.

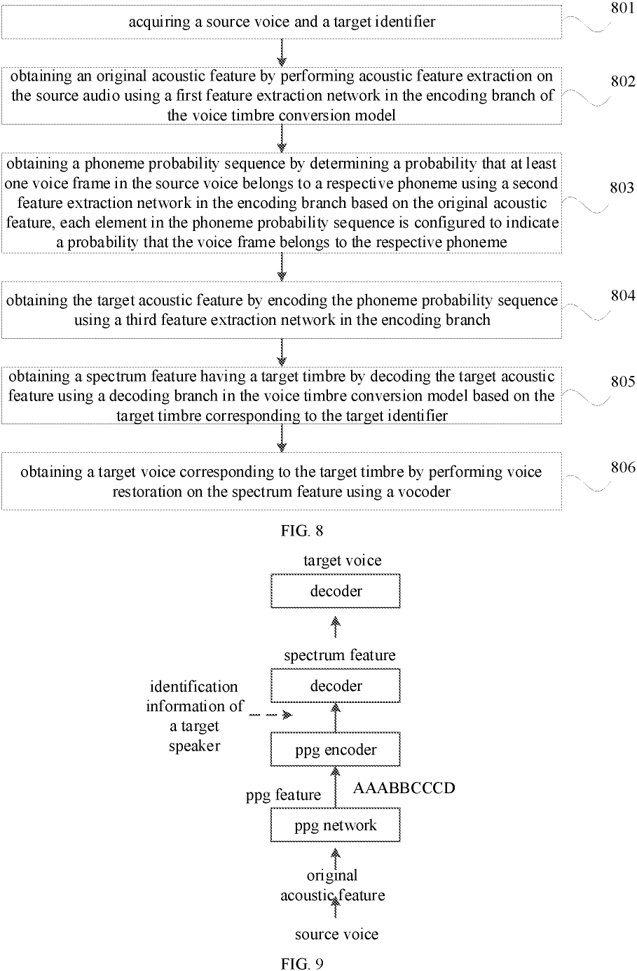

FIG. 8 is a flowchart of a method for converting a voice timbre provided in an eighth embodiment of the disclosure.

As illustrated in FIG. 8, the method for converting a voice timbre may include the following blocks.

At block 801, a source voice and a target identifier are acquired.

At block 802, an original acoustic feature is obtained by performing acoustic feature extraction on the source audio using a first feature extraction network in an encoding branch of a voice timbre conversion model.

In the embodiment of the disclosure, the original acoustic feature may be a Mel feature, a Fbank feature or other acoustic features.

In the embodiment of the disclosure, the original acoustic feature may be obtained by performing acoustic feature extraction on the source voice using the first feature extraction network in the encoding branch of the voice timbre conversion model.

At block 803, a phoneme probability sequence is obtained by determining a probability that at least one voice frame in the source voice belongs to a respective phoneme using a second feature extraction network in the encoding branch based on the original acoustic feature, each element in the phoneme probability sequence is configured to indicate a probability that the voice frame belongs to the respective phoneme.

In the embodiment of the disclosure, the phoneme probability sequence may be obtained by determining the probability that at least one voice frame in the source voice belongs to the respective phoneme using the second feature extraction network in the encoding branch in the voice timbre conversion model based on the original acoustic feature, each element in the phoneme probability sequence is configured to indicate the probability that the voice frame belongs to the respective phoneme.

For example, assuming that a duration of a source voice is 1.2 s, and one voice frame is extracted per 0.01 s, the source voice has 120 voice frames, and the phoneme probability sequence has 120 elements, each element being configured to indicate the probability that the voice frame belongs to the respective phoneme.

At block 804, a target acoustic feature is obtained by encoding the phoneme probability sequence using a third feature extraction network in the encoding branch.

In the embodiment of the disclosure, a deeper-layer acoustic feature (which may be denoted as the target acoustic feature) may be extracted by encoding the phoneme probability sequence using the third feature extraction network in the encoding branch of the voice timbre conversion model.

At block 805, a spectrum feature having a target timbre corresponding to the target identifier is obtained by decoding the target acoustic feature using a decoding branch in the voice timbre conversion model based on the target timbre.

At block 806, a target voice corresponding to the target timbre is obtained by performing voice restoration on the spectrum feature using a vocoder.

The execution process of blocks 805 to 806 may refer to an execution process of any embodiment in the disclosure, which will not be repeated here.

As an example, taking the second feature extraction network in the encoding branch being a ppg network (or a ppg submodel), the phoneme probability sequence being a ppg feature and the third feature extraction network being a ppg encoder for an example, a prediction process of the voice timbre conversion model may be as illustrated in FIG. 9, acoustic feature extraction may be performed on the source voice of the source speaker using the first feature extraction network in the encoding branch, and the extracted original acoustic feature is input into the ppg network to obtain the ppg feature, and the ppg encoder encodes the ppg feature to extract a deeper-layer acoustic feature, which is denoted as the target acoustic feature in the disclosure.

The decoder decodes the target acoustic feature based on the identification information of the target speaker, denoted as the target timbre corresponding to the target identifier, to obtain the spectrum feature having the target timbre (for example, a Mel feature), and the vocoder performs voice restoration on the above spectrum feature to obtain the target voice corresponding to the target timbre.

In the method for converting a voice timbre in the embodiment of the disclosure, the original acoustic feature is obtained by performing acoustic feature extraction on the source voice using the first feature extraction network in the encoding branch; the phoneme probability sequence is obtained by determining the probability that at least one voice frame in the source voice belongs to the respective phoneme using the second feature extraction network in the encoding branch based on the original acoustic feature, each element in the phoneme probability sequence is configured to indicate the probability that the voice frame belongs to the respective phoneme; and the target acoustic feature is obtained by encoding the phoneme probability sequence using the third feature extraction network in the encoding branch. Therefore, the target acoustic feature may be obtained by effectively encoding the source voice by three feature extraction networks in the encoding branch.

Corresponding to the method for training a model provided in any of FIGS. 1 to 5, an apparatus for training a model is further provided in the disclosure. Since the apparatus for training a model provided in the embodiment of the disclosure corresponds to a method for training a model provided in FIGS. 7 to 8, the implementation of the method for training a model is also applied to the apparatus for training a model provided in the embodiment, which will not be described in the embodiment.

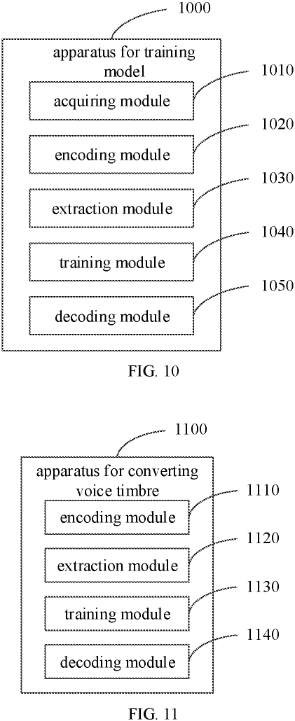

FIG. 10 is a diagram of a structure of an apparatus for training a model provided in a ninth embodiment of the disclosure.

As illustrated in FIG. 10, the apparatus 1000 for training a model may include an acquiring module 1010, an encoding module 1020, an extraction module 1030, a training module 1040 and a decoding module 1050.

The acquiring module 1010 is configured to acquire a sample audio carrying identification information.

The encoding module 1020 is configured to obtain a target acoustic feature by encoding the sample audio using an encoding branch in the voice timbre conversion model.

The extraction module 1030 is configured to obtain a target text feature by performing feature extraction on the real text sequence labeled by the sample audio.

The training module 1040 is configured to train the encoding branch based on a first difference between the target acoustic feature and the target text feature.

The decoding module 1050 is configured to obtain a first spectrum feature having an original timbre corresponding to the identification information by decoding the target text feature using a decoding branch in the voice timbre conversion model based on the original timbre.

The extraction module 1030 is further configured to obtain a second spectrum feature by performing spectrum feature extraction on the sample audio.

The training module 1040 is further configured to train the decoding branch based on a second difference between the first spectrum feature and the second spectrum feature.

In a possible implementation of the embodiment of the disclosure, the encoding module 1020 is specifically configured to: obtain an original acoustic feature by performing acoustic feature extraction on the sample audio using a first feature extraction network in the encoding branch; a phoneme probability sequence by determining a probability that at least one audio frame in the sample audio belongs to a respective phoneme using a second feature extraction network in the encoding branch based on the original acoustic feature, wherein, each element in the phoneme probability sequence is configured to indicate a probability that the audio frame belongs to the respective phoneme; and obtain the target acoustic feature by encoding the phoneme probability sequence using a third feature extraction network in the encoding branch.

In a possible implementation of the embodiment of the disclosure, the apparatus 1000 for training a model may further include a determining module and a training module 1040.

The determining module is configured to determine a predictive text sequence corresponding to the sample audio based on the phoneme probability sequence.

The training module 1040 is configured to train the second feature extraction network based on the predictive text sequence and the real text sequence.

In a possible implementation of the embodiment of the disclosure, the training module 1040 is specifically configured to: alignment processing on the real text sequence based on a length of the predictive text sequence, to cause a length of the aligned real text sequence to match the length of the predictive text sequence; and train the second feature extraction network based on a third difference between the predictive text sequence and the aligned real text sequence.

In a possible implementation of the embodiment of the disclosure, the extraction module 1030 is specifically configured to: perform alignment processing on the real text sequence based on a length of the phoneme probability sequence, to cause a length of the aligned real text sequence to match the length of the phoneme probability sequence; and obtain the target text feature by performing feature extraction on the aligned real text sequence.

In the apparatus for training a model in the embodiment of the disclosure, the target acoustic feature is obtained by encoding the sample audio using the encoding branch in the voice timbre conversion model, and the target text feature is obtained by performing feature extraction on the real text sequence labeled by the sample audio; the encoding branch is trained based on the first difference between the target acoustic feature and the target text feature, and the first spectrum feature having the original timbre corresponding to the identification information carried in the sample audio is obtained by decoding by the decoding branch in the voice timbre conversion model the target text feature based on the original timbre; the second spectrum feature is obtained by performing spectrum feature extraction on the sample audio, and the decoding branch is trained based on the second difference between the first spectrum feature and the second spectrum feature. Therefore, the encoding branch is trained based on the difference between the text feature corresponding to the real text sequence labeled by the sample audio and the acoustic feature output by the encoding branch, so that the acoustic feature output by the encoding branch is more prone to including content information (or semantic information) in the sample audio, but not including speaker information (such as timbre information), thereby improving the timbre effect of subsequent voice conversion.

Corresponding to the method for converting a voice timbre provided in FIGS. 7 to 8, an apparatus for converting a voice timbre is further provided in the disclosure. Since the apparatus for converting a voice timbre provided in the embodiment of the disclosure corresponds to a method for converting a voice timbre provided in FIGS. 7 to 8, the implementation of the method for converting a voice timbre is also applied to the apparatus for converting a voice timbre provided in the embodiment, which will not be described in the embodiment.

FIG. 11 is a diagram of a structure of an apparatus for converting a voice timbre provided in an eighth embodiment of the disclosure.

As illustrated in FIG. 11, the apparatus 1100 for converting a voice timbre may include an acquiring module 1110, an encoding module 1120, a decoding module 1130 and a restoration module 1140.

The acquiring module 1110 is configured to acquire a source voice and a target identifier.

The encoding module 1120 is configured to obtain a target acoustic feature by encoding the source voice using an encoding branch in a voice timbre conversion model.

The decoding module 1130 is configured to obtain a spectrum feature having a target timbre by decoding the target acoustic feature using a decoding branch in the voice timbre conversion model based on the target timbre corresponding to the target identifier.

The restoration module 1140 is configured to obtain a target voice corresponding to the target timbre by performing voice restoration on the spectrum feature using a vocoder.

In a possible implementation of the embodiment of the disclosure, the encoding module 1130 is specifically configured to: obtain an original acoustic feature by performing acoustic feature extraction on the source voice using a first feature extraction network in the encoding branch; obtain a phoneme probability sequence by determining a probability that at least one voice frame in the source voice belongs to a respective phoneme using a second feature extraction network in the encoding branch based on the original acoustic feature, wherein, each element in the phoneme probability sequence is configured to indicate a probability that the voice frame belongs to the respective phoneme; and obtain the target acoustic feature by encoding the phoneme probability sequence using a third feature extraction network in the encoding branch.

In the apparatus for converting a voice timbre in the embodiment of the disclosure, the source voice and the target identifier are acquired, and the target acoustic feature is obtained by encoding the source voice using the encoding branch in the voice timbre conversion model; the spectrum feature having the target timbre corresponding to the target identifier is obtained by decoding the target acoustic feature using the decoding branch in the voice timbre conversion model based on the target timbre; and the target voice corresponding to the target timbre is obtained by performing voice restoration on the spectrum feature using the vocoder. Therefore, timbre conversion is performed on a voice based on a deep learning technology, which may improve a timbre conversion effect.

In order to achieve the above embodiment, an electronic device is further provided in the disclosure. The electronic device may include at least one processor; and a memory communicatively connected to the at least one processor; the memory is stored with instructions executable by the at least one processor, and the instructions are performed by the at least one processor, so that the at least one processor may perform the method for converting a voice timbre or the method for training a model provided in the above any embodiment of the disclosure.

In order to achieve the above embodiment, a non-transitory computer readable storage medium stored with computer instructions is further provided, the computer instructions are configured to perform the method for converting a voice timbre or the method for training a model as described in the above any embodiment of the disclosure by a computer.

In order to achieve the above embodiment, a computer program product including a computer program is further provided, the computer program is configured to perform the method for converting a voice timbre or the method for training a model as described in the above any embodiment of the disclosure when performed by a processor.

According to the embodiment of the disclosure, an electronic device, a readable storage medium and a computer program product are further provided in the disclosure.

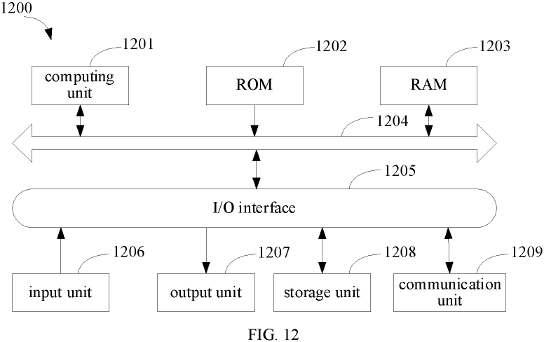

FIG. 12 is a schematic block diagram illustrating an example electronic device in any embodiment of the disclosure. An electronic device is intended to represent various types of digital computers, such as laptop computers, desktop computers, workstations, personal digital assistants, servers, blade servers, mainframe computers, and other suitable computers. An electronic device may also represent various types of mobile apparatuses, such as personal digital assistants, cellular phones, smart phones, wearable devices, and other similar computing devices. The components shown herein, their connections and relations, and their functions are merely examples, and are not intended to limit the implementation of the disclosure described and/or required herein.

As illustrated in FIG. 12, a device 1200 includes a computing unit 1201, which may be configured to execute various appropriate actions and processes according to a computer program stored in a read-only memory (ROM) 1202 or loaded from a storage unit 808 to a random-access memory (RAM) 1203. In a RAM 1203, various programs and data required for a device 1200 may be stored. A computing unit 1201, a ROM 1202 and a RAM 1203 may be connected with each other by a bus 1204. An input/output (I/O) interface 1205 is also connected to a bus 1204.

A plurality of components in the device 1200 are connected to an I/O interface 1205, and includes: an input unit 1206, for example, a keyboard, a mouse, etc; an output unit 1207, for example various types of displays, speakers; a storage unit 1208, for example a magnetic disk, an optical disk; and a communications unit 1209, for example, a network card, a modem, a wireless transceiver. A communications unit 1209 allows a device 1200 to exchange information/data through a computer network such as internet and/or various types of telecommunication networks and other devices.

A computing unit 1201 may be various types of general and/or dedicated processing components with processing and computing ability. Some examples of a computing unit 1201 include but not limited to a central processing unit (CPU), a graphics processing unit (GPU), various dedicated artificial intelligence (AI) computing chips, various computing units running a machine learning model algorithm, a digital signal processor (DSP), and any appropriate processor, controller, microcontroller, etc. The computing unit 1201 performs various methods and processings as described above, for example, the method for converting a voice timbre or the method for training a model. For example, in some embodiments, the method for converting a voice timbre or the method for training a model may be further achieved as a computer software program, which is physically contained in a machine-readable medium, such as a storage unit 1208. In some embodiments, a part or all of the computer program may be loaded and/or installed on the device 1200 through a ROM 1202 and/or a communication unit 1209. When the computer program is loaded on a RAM 1203 and executed by a computing unit 1201, one or more blocks in the method for converting a voice timbre or the method for training a model as described above may be performed. Alternatively, in other embodiments, a computing unit 1201 may be configured to perform the method for converting a voice timbre or the method for training a model in other appropriate ways (for example, by virtue of a firmware).

Various implementation modes of systems and technologies described herein may be implemented in a digital electronic circuit system, an integrated circuit system, a field programmable gate array (FPGA), a dedicated application specific integrated circuit (ASIC), an application specific standard product (ASSP), a system on a chip (SoC), a complex programmable logic device (CPLD), a computer hardware, a firmware, a software, and/or combinations thereof. The various implementation modes may include: being implemented in one or more computer programs, and the one or more computer programs may be executed and/or interpreted on a programmable system including at least one programmable processor, and the programmable processor may be a dedicated or a general-purpose programmable processor that may receive data and instructions from a storage system, at least one input apparatus, and at least one output apparatus, and transmit the data and instructions to the storage system, the at least one input apparatus, and the at least one output apparatus.

A computer code configured to execute a method in the present disclosure may be written with one or any combination of a plurality of programming languages. The programming languages may be provided to a processor or a controller of a general-purpose computer, a dedicated computer, or other apparatuses for programmable data processing so that the function/operation specified in the flowchart and/or block diagram may be performed when the program code is executed by the processor or controller. A computer code may be performed completely or partly on the machine, performed partly on the machine as an independent software package and performed partly or completely on the remote machine or server.

In the context of the disclosure, a machine-readable medium may be a tangible medium that may contain or store a program intended for use in or in conjunction with an instruction execution system, apparatus, or device. A machine-readable medium may be a machine-readable signal medium or a machine-readable storage medium. A machine-readable storage medium may include but not limited to an electronic, magnetic, optical, electromagnetic, infrared, or semiconductor system, apparatus or device, or any appropriate combination thereof. A more specific example of a machine-readable storage medium includes an electronic connector with one or more cables, a portable computer disk, a hardware, a RAM, a ROM, an electrically programmable read-only memory (an EPROM) or a flash memory, an optical fiber device, and a compact disc read-only memory (CD-ROM), an optical storage device, a magnetic storage device, or any appropriate combination thereof.

In order to provide interaction with the user, the systems and technologies described here may be implemented on a computer, and the computer has: a display apparatus for displaying information to the user (for example, a CRT (cathode ray tube) or an LCD (liquid crystal display) monitor); and a keyboard and a pointing apparatus (for example, a mouse or a trackball) through which the user may provide input to the computer. Other types of apparatuses may be further configured to provide interaction with the user; for example, the feedback provided to the user may be any form of sensory feedback (for example, visual feedback, auditory feedback, or tactile feedback); and input from the user may be received in any form (including an acoustic input, a voice input, or a tactile input).

The systems and technologies described herein may be implemented in a computing system including back-end components (for example, as a data server), or a computing system including middleware components (for example, an application server), or a computing system including front-end components (for example, a user computer with a graphical user interface or a web browser through which the user may interact with the implementation mode of the system and technology described herein), or a computing system including any combination of such back-end components, middleware components or front-end components. The system components may be connected to each other through any form or medium of digital data communication (for example, a communication network). The examples of a communication network include a Local Area Network (LAN), a Wide Area Network (WAN), an internet and a blockchain network.

The computer system may include a client and a server. The client and server are generally far away from each other and generally interact with each other through a communication network. The relationship between the client and the server is generated by computer programs running on the corresponding computer and having a client-server relationship with each other. A server may be a cloud server, also known as a cloud computing server or a cloud host, is a host product in a cloud computing service system, to solve the shortcomings of large management difficulty and weak business expansibility existed in the traditional physical host and Virtual Private Server (VPS) service. A server further may be a server with a distributed system, or a server in combination with a blockchain.

It should be noted that, Artificial intelligence (AI) is a subject that learns simulating certain thinking processes and intelligent behaviors (such as learning, reasoning, thinking, planning, etc.) of human beings by a computer, which covers hardware-level technologies and software-level technologies. AI hardware technologies generally include technologies such as sensors, dedicated AI chips, cloud computing, distributed storage, big data processing, etc.; AI software technologies mainly include computer vision technology, speech recognition technology, natural language processing (NLP) technology and machine learning (ML), deep learning (DL), big data processing technology, knowledge graph (KG) technology, etc.

Based on the technical solution in the embodiment of the disclosure, the target acoustic feature is obtained by encoding the sample audio using the encoding branch in the voice timbre conversion model, and the target text feature is obtained by performing feature extraction on the real text sequence labeled by the sample audio; the encoding branch is trained based on the first difference between the target acoustic feature and the target text feature, and the first spectrum feature having the original timbre corresponding to the identification information carried in the sample audio is obtained by decoding by the decoding branch in the voice timbre conversion model the target text feature based on the original timbre; the second spectrum feature is obtained by performing spectrum feature extraction on the sample audio, and the decoding branch is trained based on the second difference between the first spectrum feature and the second spectrum feature. Therefore, the encoding branch is trained based on the difference between the text feature corresponding to the real text sequence labeled by the sample audio and the acoustic feature output by the encoding branch, so that the acoustic feature output by the encoding branch is more prone to including content information (or semantic information) in the sample audio, but not including speaker information (such as timbre information), thereby improving the timbre effect of subsequent voice conversion.

It should be understood that, various forms of procedures shown above may be configured to reorder, add or delete blocks. For example, blocks described in the disclosure may be performed in parallel, sequentially, or in a different order, as long as the desired result of the technical solution disclosed in the present disclosure may be achieved, which will not be limited herein.

The above specific implementations do not constitute a limitation on the protection scope of the disclosure. Those skilled in the art should understand that various modifications, combinations, sub-combinations and substitutions may be made according to design requirements and other factors. Any modification, equivalent replacement, improvement, etc., made within the spirit and principle of embodiments of the present disclosure shall be included within the protection scope of the present disclosure.

What is claimed is:

1. A method for training a model, comprising:
acquiring a sample audio carrying identification information, and obtaining a target acoustic feature by encoding the sample audio using an encoding branch in a voice timbre conversion model;
obtaining a target text feature by performing feature extraction on a real text sequence labeled by the sample audio;
training the encoding branch based on a first difference between the target acoustic feature and the target text feature, and obtaining a first spectrum feature having an original timbre corresponding to the identification information by decoding the target text feature using a decoding branch in the voice timbre conversion model based on the original timbre; and
obtaining a second spectrum feature by performing spectrum feature extraction on the sample audio, and training the decoding branch based on a second difference between the first spectrum feature and the second spectrum feature.

2. The method of claim 1, wherein, obtaining the target acoustic feature by encoding the sample audio using the encoding branch in the voice timbre conversion model, comprises:
obtaining an original acoustic feature by performing acoustic feature extraction on the sample audio using a first feature extraction network in the encoding branch;
obtaining a phoneme probability sequence by determining a probability that at least one audio frame in the sample audio belongs to a respective phoneme using a second feature extraction network in the encoding branch based on the original acoustic feature, wherein, each element in the phoneme probability sequence is configured to indicate a probability that the audio frame belongs to the respective phoneme; and
obtaining the target acoustic feature by encoding the phoneme probability sequence using a third feature extraction network in the encoding branch.

3. The method of claim 2, further comprising:
determining a predictive text sequence corresponding to the sample audio based on the phoneme probability sequence; and
training the second feature extraction network based on the predictive text sequence and the real text sequence.

4. The method of claim 3, wherein, training the second feature extraction network based on the predictive text sequence and the real text sequence, comprises:
performing alignment processing on the real text sequence based on a length of the predictive text sequence, to cause a length of the aligned real text sequence to match the length of the predictive text sequence; and
training the second feature extraction network based on a third difference between the predictive text sequence and the aligned real text sequence.

5. The method of claim 2, wherein, obtaining the target text feature by performing feature extraction on the real text sequence labeled by the sample audio, comprises:
performing alignment processing on the real text sequence based on a length of the phoneme probability sequence, to cause a length of the aligned real text sequence to match the length of the phoneme probability sequence; and
obtaining the target text feature by performing feature extraction on the aligned real text sequence.

6. The method of claim 1, wherein, training the encoding branch based on the first difference between the target acoustic feature and the target text feature, comprises:
generating a first lost function corresponding to the encoding branch based on the first difference, wherein the first function is positively related to the first difference; and
training the encoding branch with a termination condition of minimizing a value of the first function.

7. The method of claim 1, wherein, training the encoding branch based on the first difference between the target acoustic feature and the target text feature, comprises:
generating a first lost function corresponding to the encoding branch based on the first difference, wherein the first function is positively related to the first difference; and
training the encoding branch with a termination condition of a number of times of training reaching a preset threshold.

8. The method of claim 1, wherein, training the decoding branch based on the second difference between the first spectrum feature and the second spectrum feature, comprises:
generating a second lost function corresponding to the decoding branch based on the second difference, wherein the second function is positively related to the second difference; and
training the decoding branch with a termination condition of minimizing a value of the second function.

9. The method of claim 1, wherein, training the decoding branch based on the second difference between the first spectrum feature and the second spectrum feature, comprises:
generating a second lost function corresponding to the decoding branch based on the second difference, wherein the second function is positively related to the second difference; and
training the decoding branch with a termination condition of a number of times of training reaching a preset threshold.

10. The method of claim 4, wherein, training the second feature extraction network based on the third difference between the predictive text sequence and the aligned real text sequence, comprises:
generating a third lost function corresponding to the second feature extraction network based on the third difference, wherein the third function is positively related to the third difference; and
training the second feature extraction network with a termination condition of minimizing a value of the third function.

11. The method of claim 4, wherein, training the second feature extraction network based on the third difference between the predictive text sequence and the aligned real text sequence, comprises:
generating a third lost function corresponding to the second feature extraction network based on the third difference, wherein the third function is positively related to the third difference; and
training the second feature extraction network with a termination condition of a number of times of training reaching a preset threshold.

12. A method for converting a voice timbre, comprising:
acquiring a source voice and a target identifier;
obtaining a target acoustic feature by encoding the source voice using an encoding branch in a voice timbre conversion model;
obtaining a spectrum feature having a target timbre by decoding the target acoustic feature using a decoding branch in the voice timbre conversion model based on the target timbre corresponding to the target identifier; and
obtaining a target voice corresponding to the target timbre by performing voice restoration on the spectrum feature using a vocoder.

13. The method of claim 12, wherein, obtaining the target acoustic feature by encoding the source voice using the encoding branch in the voice timbre conversion model, comprises:
obtaining an original acoustic feature by performing acoustic feature extraction on the source voice using a first feature extraction network in the encoding branch;
obtaining a phoneme probability sequence by determining a probability that at least one voice frame in the source voice belongs to a respective phoneme using a second feature extraction network in the encoding branch based on the original acoustic feature, wherein, each element in the phoneme probability sequence is configured to indicate a probability that the voice frame belongs to the respective phoneme; and
obtaining the target acoustic feature by encoding the phoneme probability sequence using a third feature extraction network in the encoding branch.

14. An electronic device, comprising:
at least one processor; and
a memory communicatively connected to the at least one processor; wherein,
the memory is stored with instructions executable by the at least one processor, when the instructions are performed by the at least one processor, the at least one processor is caused to perform the method for training a model, comprising:
acquiring a sample audio carrying identification information, and obtaining a target acoustic feature by encoding the sample audio using an encoding branch in a voice timbre conversion model;
obtaining a target text feature by performing feature extraction on a real text sequence labeled by the sample audio;
training the encoding branch based on a first difference between the target acoustic feature and the target text feature, and obtaining a first spectrum feature having an original timbre corresponding to the identification information by decoding the target text feature using a decoding branch in the voice timbre conversion model based on the original timbre; and
obtaining a second spectrum feature by performing spectrum feature extraction on the sample audio, and training the decoding branch based on a second difference between the first spectrum feature and the second spectrum feature.

15. The device of claim 14, wherein, obtaining the target acoustic feature by encoding the sample audio using the encoding branch in the voice timbre conversion model, comprises:
obtaining an original acoustic feature by performing acoustic feature extraction on the sample audio using a first feature extraction network in the encoding branch;
obtaining a phoneme probability sequence by determining a probability that at least one audio frame in the sample audio belongs to a respective phoneme using a second feature extraction network in the encoding branch based on the original acoustic feature, wherein, each element in the phoneme probability sequence is configured to indicate a probability that the audio frame belongs to the respective phoneme; and
obtaining the target acoustic feature by encoding the phoneme probability sequence using a third feature extraction network in the encoding branch.

16. The device of claim 15, wherein the at least one processor is further caused to perform:
determining a predictive text sequence corresponding to the sample audio based on the phoneme probability sequence; and
training the second feature extraction network based on the predictive text sequence and the real text sequence.

17. The device of claim 16, wherein, training the second feature extraction network based on the predictive text sequence and the real text sequence, comprises:
performing alignment processing on the real text sequence based on a length of the predictive text sequence, to cause a length of the aligned real text sequence to match the length of the predictive text sequence; and
training the second feature extraction network based on a third difference between the predictive text sequence and the aligned real text sequence.

18. The device of claim 15, wherein, obtaining the target text feature by performing feature extraction on the real text sequence labeled by the sample audio, comprises:
performing alignment processing on the real text sequence based on a length of the phoneme probability sequence, to cause a length of the aligned real text sequence to match the length of the phoneme probability sequence; and
obtaining the target text feature by performing feature extraction on the aligned real text sequence.

19. The device of claim 14, wherein, training the encoding branch based on the first difference between the target acoustic feature and the target text feature, comprises:
generating a first lost function corresponding to the encoding branch based on the first difference, wherein the first function is positively related to the first difference; and
training the encoding branch with a termination condition of minimizing a value of the first function.

20. The device of claim 14, wherein, training the encoding branch based on the first difference between the target acoustic feature and the target text feature, comprises:
generating a first lost function corresponding to the encoding branch based on the first difference, wherein the first function is positively related to the first difference; and
training the encoding branch with a termination condition of a number of times of training reaching a preset threshold.
